(19) United States
(12) Patent Application Publication
(10) Pub. No.: US 2011/0249231 A1
(43) Pub. Date: Oct. 13, 2011

(54) GLASSES ASSEMBLY

(76) Inventor: Mei Yueh Hou, Yongkang City (TW)

(21) Appl. No.: 12/758,010

(22) Filed: Apr. 11, 2010

(51) Int. Cl. G02C 5/14

(52) U.S. Cl. 351/116; 351/156

(57) ABSTRACT

A glasses assembly includes a frame made of slightly flexible material. The frame includes two sides each having a column extending therefrom. Each column includes a snapping member. At least one lens is mounted to the frame. The glasses assembly further includes two coupling blocks each having a snapping portion at a first end thereof and a coupling portion at a second end thereof. The snapping portion includes a groove and a recess in communication with the groove. The coupling blocks are mounted to the sides of the frame with each column received in the groove of the snapping portion of one of the coupling blocks and with the snapping member of the column engaged in the recess. A wearing unit is engaged with the coupling portions of the coupling blocks. The wearing unit can be a pair of temples or a head strap.

### BACKGROUND OF THE INVENTION

1. Field of the Invention

The present invention relates to a glasses assembly and, more particularly, to a glasses assembly including a frame allowing selective attachment of a pair of temples or a head strap.

2. Description of the Related Art

Conventional glasses include a frame, one or two lenses, and a pair of temples or a head strap allowing wearing of the glasses on a head of a user. The frame includes a temple coupling portion or a strap coupling portion on each of two sides thereof. Each temple coupling portion includes a pivot hole for pivotal connection with an end of one of the temples. Each strap coupling portion includes a slot through which the head strap extends. However, the temple coupling portions can not be utilized with the head strap, nor can the strap coupling portions be utilized with the temples. The manufacturers have to manufacture two types of frames, leading to an increase in the costs. Furthermore, the user has to carry to two pairs of glasses, one with temples for general situations and the other with a head strap for preventing the glasses from falling in sports situations, leading to inconvenience to the user.

Thus, a need exists for a pair of glasses including a frame allowing selective attachment of a pair of temples or a head strap according to needs while allowing easy assembly.

### BRIEF SUMMARY OF THE INVENTION

The present invention solves this need and other problems in the field of glasses by providing, in a first aspect, a glasses assembly including a frame made of slightly flexible material. The frame includes two sides each having a column extending therefrom. Each column includes a snapping member. At least one lens is mounted to the frame. The glasses assembly further includes two coupling blocks each having a snapping portion at a first end thereof and a coupling portion at a second end thereof. The snapping portion includes a groove and a recess in communication with the groove. The coupling blocks are mounted to the sides of the frame with each column received in the groove of the snapping portion of one of the coupling blocks and with the snapping member of the column engaged in the recess. A wearing unit is engaged with the coupling portions of the coupling blocks. The wearing unit can be a pair of temples or a head strap.

In a second aspect, a glasses assembly according to the teachings of the present invention includes a frame made of slightly flexible material. The frame includes two sides each having a column extending therefrom. Each column includes a snapping member. At least one lens is mounted to the frame. The glasses assembly further includes two first coupling blocks each having a first snapping portion at a first end thereof and a first coupling portion at a second end thereof. The first snapping portion includes a first groove and a first recess in communication with the first groove. The glasses assembly further includes two second coupling blocks each having a second snapping portion at a first end thereof and a second coupling portion at a second end thereof. The second snapping portion includes a second groove and a second recess in communication with the second groove. The glasses assembly further includes a pair of temples and a head strap. The two first coupling blocks and the two second coupling blocks are selectively mounted to the two sides of the frame. When the first coupling blocks are mounted to the frame, each column is received in the first groove of the first snapping portion of one of the first coupling blocks with the snapping member of the column engaged in the first recess, and the pair of temples is engaged with the first coupling portions of the first coupling blocks. On the other hand, when the second coupling blocks are mounted to the frame, each column is received in the second groove of the second snapping portion of one of the second coupling blocks with the snapping member of the column engaged in the second recess, and the head strap is engaged with the second coupling portions of the second coupling blocks.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows an exploded, perspective view of a glasses assembly of an embodiment according to the preferred teachings of the present invention.

FIG. 2 shows a perspective view of the glasses assembly of FIG. 1.

FIG. 3 shows a partial, cross sectional view of the glasses assembly of FIG. 1.

FIG. 4 shows another partial, cross sectional view of the glasses assembly of FIG. 1.

FIG. 5 shows an exploded, perspective view of a glasses assembly of another embodiment according to the preferred teachings of the present invention.

FIG. 6 shows a perspective view of the glasses assembly of FIG. 5.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

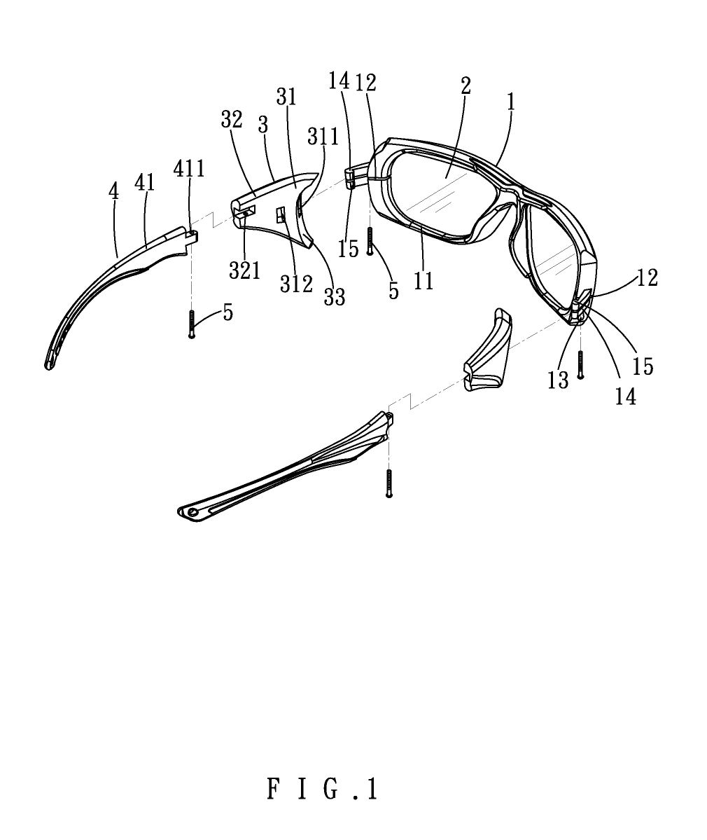

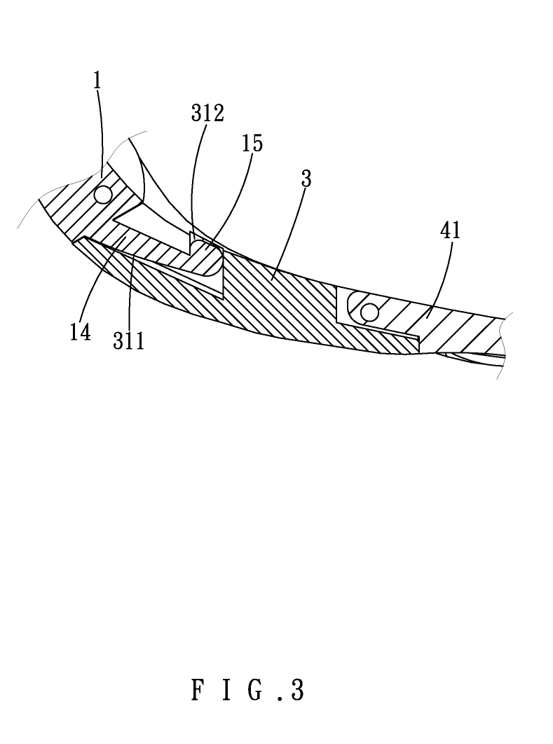

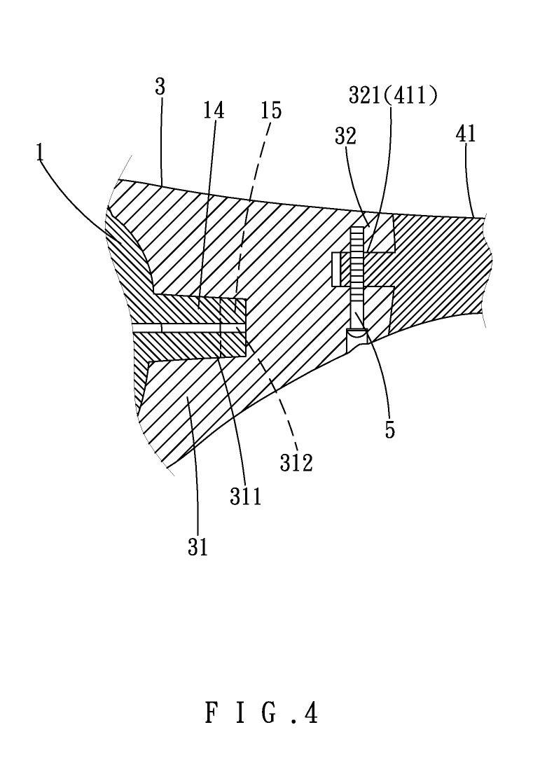

With reference to FIG. 1, a glasses assembly according to the preferred teachings of the present invention includes a frame 1, one or two lenses 2, two coupling blocks 3, and a wearing unit 4. The frame 1 is made of slightly flexible material and includes one or two receiving grooves 11 for receiving the lenses 2. Each receiving groove 11 includes a slit 12 in a peripheral wall thereof to allow expansion of the receiving groove 11. A fixing hole 13 is formed adjacent each slit 12. The lenses 2 are mounted in the receiving grooves 11, and fasteners 5 are threadedly engaged in the fixing holes 13 to securely retain the lenses 2 in the frame 1. It can be appreciated that lenses 2 can be optical lenses or sunglasses of any desired type. Furthermore, a column 14 extends rearwards from each of two sides of the frame 1. Each column 14 includes a snapping member 15 formed on an inner face thereof. In the preferred form shown in FIGS. 1-6, each column 14 includes two parallel posts each having an end integrally formed with one of the sides of the frame 1 and on opposite sides of one of the slits 13.

Each coupling block 3 includes a snapping portion 31 at a first end thereof and a coupling portion 32 at a second end thereof. The first end of each snapping block 3 includes an arcuate end face 33 complementary to one of the sides of the frame 1. The snapping portion 31 includes a groove 311 facing one of the columns 14. The snapping portion 31 further includes a recess 312 formed in an inner face thereof and in communication with the groove 311. The coupling portion 32 includes a pivot hole 321 for coupling with the wearing unit 4.

In the preferred form shown in FIGS. 1-4, the wearing unit 4 includes a pair of temples 41 each having a pivot hole 411 in an end thereof. A fastener 5 can be extended through the pivot hole 321 of each coupling block 3 and the pivot hole 411 of one of the temples 41 to pivotably connect the coupling block 3 to the temple 41.

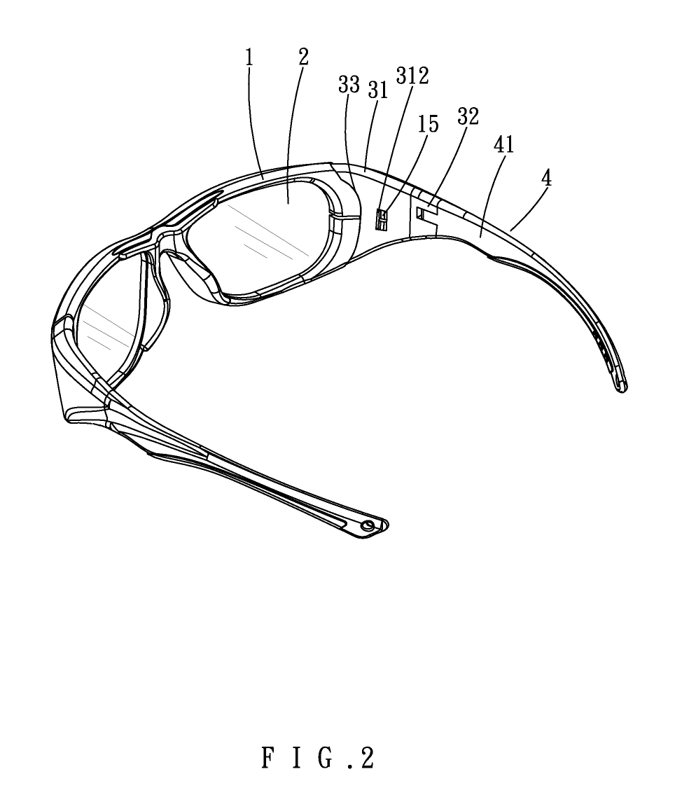

With reference to FIGS. 2-4, in assembly, each coupling block 3 is mounted to one of the sides of the frame 1 with the grooves 311 receiving the columns 14 and with the snapping members 15 engaged in the recesses 312. The assembly is simple and reliable. The snapping members 15 and the recess 312 are located in inner sides of the coupling blocks 3 and, thus, will be shielded when the glasses assembly is worn on a head of a user, providing an aesthetic appearance.

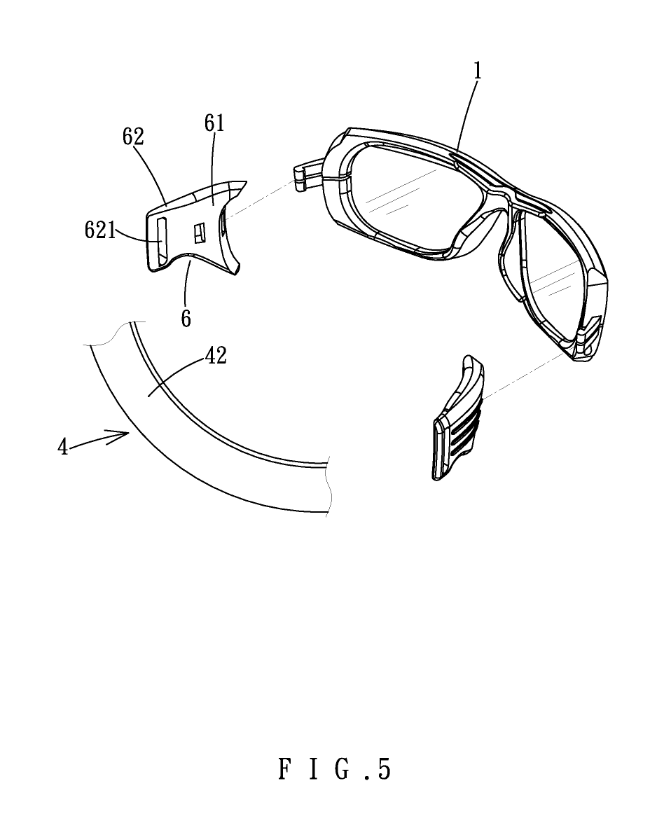

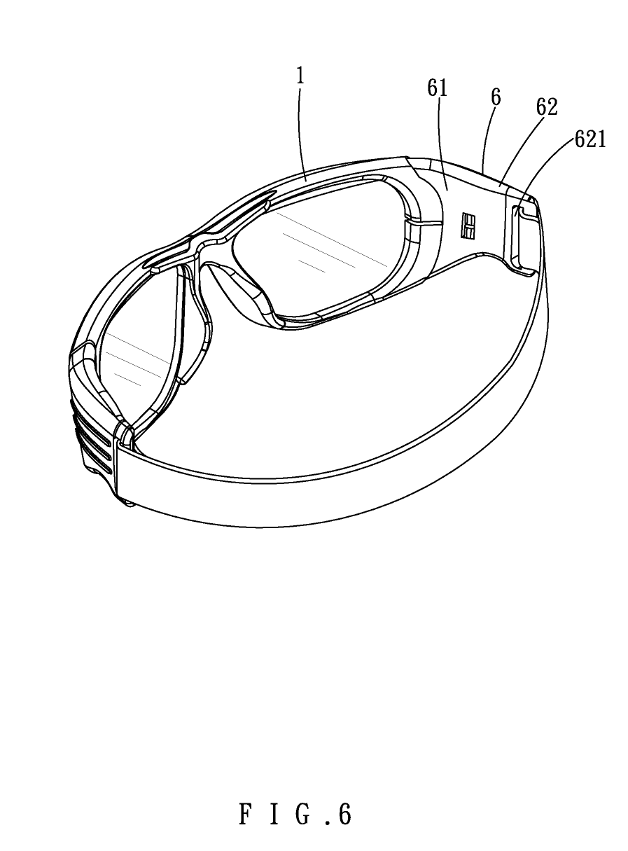

The frame 1 according to the preferred teachings of the present invention can be utilized with coupling blocks 6 of another type for coupling with a head strap. Specifically, each coupling block 6 (FIGS. 5 and 6) includes a snapping portion 61 at a first end thereof and a coupling portion 62 at a second end thereof. The snapping portion 61 is identical to the snapping portion 31 of the snapping block 3. The coupling portion 62 includes a slot 621. In the preferred form shown in FIGS. 5-6, the wearing unit 4 is a head strap 42 extending through the slot 621 of each coupling block 6.

Thus, the frame 1 can be selectively utilized with a pair of temples 41 or a head strap 42 through use of the coupling blocks 3 or the coupling blocks 6 according to needs. Detachment and attachment of the coupling blocks 3 and 6 are simple and easy. Thus, the manufacturing costs of the frame 1 can be cut while providing an economic assembly for users.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A glasses assembly comprising:
a frame made of slightly flexible material, with the frame including two sides each having a column extending therefrom, with each of the columns including a snapping member;
at least one lens mounted to the frame;
two coupling blocks each including a snapping portion at a first end thereof and a coupling portion at a second end thereof, with the snapping portion including a groove and a recess in communication with the groove, with the two coupling blocks mounted to the two sides of the frame with each of the columns received in the groove of the snapping portion of one of the two coupling blocks and with the snapping member of the column engaged in the recess; and
a wearing unit engaged with the coupling portions of the two coupling blocks.

2. The glasses assembly as claimed in claim 1, with each of the snapping members being formed on an inner face of one of the columns, and with each of the recesses being formed on an inner face of one of the snapping portions.

3. The glasses assembly as claimed in claim 1, with the coupling portion of each of the two coupling blocks including a first pivot hole, with the wearing unit including a pair of temples each having an end with a second pivot hole, with a fastener extending through the first and second pivot holes to pivotably connect each of the pair of temples to the coupling portion of one of the two coupling blocks.

4. The glasses assembly as claimed in claim 1, with the coupling portion of each of the two coupling blocks including a slot, with the wearing unit including a head strap extending through the slot of each of the two coupling blocks.

5. A glasses assembly comprising:
a frame made of slightly flexible material, with the frame including two sides each having a column extending therefrom, with each of the columns including a snapping member;
at least one lens mounted to the frame;
two first coupling blocks each including a first snapping portion at a first end thereof and a first coupling portion at a second end thereof, with the first snapping portion including a first groove and a first recess in communication with the first groove;
two second coupling blocks each including a second snapping portion at a first end thereof and a second coupling portion at a second end thereof, with the second snapping portion including a second groove and a second recess in communication with the second groove;
a pair of temples; and
a head strap,
with the two first coupling blocks and the two second coupling blocks being selectively mounted to the two sides of the frame,
wherein when the two first coupling blocks are mounted to the frame, each of the columns is received in the first groove of the first snapping portion of one of the two first coupling blocks with the snapping member of the column engaged in the first recess, and the pair of temples is engaged with the first coupling portions of the two first coupling blocks, and
wherein when the two second coupling blocks are mounted to the frame, each of the columns is received in the second groove of the second snapping portion of one of the two second coupling blocks with the snapping member of the column engaged in the second recess, and the head strap is engaged with the second coupling portions of the two second coupling blocks.

6. The glasses assembly as claimed in claim 5, with the first snapping portion of each of the two first coupling blocks identical to the second snapping portion of each of the two second coupling blocks.
